(19) United States
(12) Patent Application Publication
(10) Pub. No.: US 2013/0127596 A1
(43) Pub. Date: May 23, 2013

(54) METHOD AND APPARATUS FOR DETERMINING A LOCATION OF AN ITEM ATTACHED TO A RADIO FREQUENCY IDENTIFICATION TAG

(71) Applicants: BINIT JAIN, SCHAUMBURG, IL (US); RANDY L. EKL, LAKE ZURICH, IL (US); DANIEL S. GRIESMANN, VILLA PARK, IL (US)

(72) Inventors: BINIT JAIN, SCHAUMBURG, IL (US); RANDY L. EKL, LAKE ZURICH, IL (US); DANIEL S. GRIESMANN, VILLA PARK, IL (US)

(73) Assignee: MOTOROLA SOLUTIONS, INC., SCHAUMBURG, IL (US)

(21) Appl. No.: 13/302,031

(22) Filed: Nov. 22, 2011

(51) Int. Cl. G06K 7/01

(52) U.S. Cl. 340/10.1

(57) ABSTRACT

A server in communications with two or more Radio Frequency Identification (RFID) readers receives information obtained by the two or more RFID readers within a coverage area. The received information is associated with the at least one item tag. The server assigns a predefined number of votes for the at least one item tag to fixed objects on which items attached to item tags are located. The predefined number of votes assigned to each fixed object is based in part on the received information. The server also calculates votes assigned to the fixed objects and determines the location of the at least one item tag to be a fixed object whose votes meet a predefined criterion.

### FIELD OF THE DISCLOSURE

The present disclosure relates generally to locating an item attached to a Radio Frequency Identification (RFID) tag and more particularly to determining a location of the item using the RFID tag attached to the item.

### BACKGROUND

RFID systems have become increasingly prevalent and can be used to identify people as well as objects. An RFID system may be configured to include at least one RFID reader (also referred to herein as reader) and one or more RFID tags (also referred to herein as tags). The RFID reader is configured to transmit and receive radio frequency (RF) signals from one or more tags within a certain range. RFID tags are typically compact and are attachable to objects. RFID tags are configured to include an integrated circuit for storing and processing information, modulating and demodulating RF signals, and performing other specialized functions. RFID tags may include an antenna in communication with the integrated circuit, wherein the antenna is used for transmitting RF signals to and receiving RF signals from the RFID reader. A RFID tag is usually tuned to a particular frequency band. RFID tags may be active tags (i.e. with an internal power source and a conventional radio transmitter), passive tags (i.e. without an internal power source and a conventional radio transmitter), or semi-passive tags (i.e. with a local battery to simulate the tag circuitry, but without a conventional radio transmitter).

In some implementations, RFID systems are deployed as part of an inventory management system in order to track how many items are in an inventory and the locations of items in the inventory. During operations in, for example, a retail establishment, customers may move items from their original display locations. When an item is placed in another location and if the new location is also covered by the RFID system, the item still shows up in the inventory management system as being available. However, a sales associate or another customer may be unable to locate the item, thereby resulting in lost sales for the establishment. To ensure that items are properly placed in their original locations, employees of the establishment will have to find and return misplaced items to their display original locations, thereby increasing the operating cost for the establishment.

To maintain an accurate, up-to-date inventory of items for sale, the retail establishment may deploy an inventory tracking system for tracking the location of each item in the establishment. The inventory tracking system may include RFID readers that may be distributed throughout the establishment. Each reader periodically interrogates the RFID tags within its coverage area, i.e. each reader sends RF signals to and receives RF signals from tags within its coverage area. After interrogating the tags for a predefined length of time (interrogation length), the readers may send a list of read tag identifiers (IDs) to a central server via, for example, Wireless Fidelity (Wi-Fi). In one system, RFID tags are attached to items and a proximate location of an item can be determined based on the reader interrogating the tag, i.e. the proximate location of the item can be determined to be a general location within the coverage range for the reader that reads signals transmitted from the tag attached to the item. Therefore, this system only determines the proximate location of the item. It does not provide an avenue for determining a location of the item attached to the tag, wherein the location is a specific shelf or rack on which the item is located.

Another system also determines the proximate locations of movable items by using reference tags. Reference tags are typically affixed to specific fixed locations, for example, shelves or racks in the retail establishment. This system in itself cannot determine the location of any specific item. This system identifies the trajectories of moving objects by capturing variations in received signal strength indication (RSSI) readings of reference tags fixed on a particular area or route. When an object crosses reference tags on its path, there are variations in RSSI signals of the readings from the reference tags and these variations let the system know that one or more objects have passed particular points. Therefore, this system is more like a route tracking system than a location identifying system for determining the location of any particular item. This system cannot differentiate between the locations of two or more moving objects.

In another system, RFID tags may be attached to movable items and the locations of movable items may be tracked by using RFID and Global Positioning Satellite (GPS) technologies. In this system, a first reader periodically receives identification information from a RFID tag attached to a movable item via the RFID signal sent from the RFID tag. If the RFID tag is associated with the first reader, location information associated with the identification information from the RFID tag can be updated using GPS technology. If the RFID tag is not associated with the first reader, the identification information from the RFID tag is sent to a second reader and location information associated with the identification information from the RFID tag can be updated using GPS technology if the tag is associated with the second reader. GPS technology is not reliable in that is does not work accurately inside a building. In addition, the granularity of location determination performed by this system is not specific to a rack or shelf, but is generally made to a location within a reader's coverage range.

Accordingly, a method and apparatus is needed for determining a location of an item using RFID technology.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a RFID tracking system used in accordance with some embodiments.

FIG. 2 is a block diagram of a RFID reader used in accordance with some embodiments.

FIG. 3 is a block diagram of a RFID tag used in accordance with some embodiments.

FIG. 4 is a flow diagram of a method for determining a location of at least one item tag in accordance with some embodiments.

FIG. 5 is a block diagram of a server configured to determine the location of at least one item tag in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses of determining a location of at least one item tag. A server in communications with two or more RFID readers receives information obtained by the two or more RFID readers within a coverage area. The received information is associated with the at least one item tag. The server assigns a predefined number of votes for the at least one item tag to fixed objects on which items attached to item tags are located. The predefined number of votes assigned to each fixed object is based in part on the received information. The server also calculates votes assigned to the fixed objects and determines the location of the at least one item tag to be a fixed object whose votes meet a predefined criterion.

Unlike traditional systems that can determine a general location of an item tag based solely on the coverage range of a reader that reads signals transmitted from the item tag, embodiments of the present invention determine a more precise location of the at least one item tag to fixed objects on which items attached to item tags are located. For example, the fixed object may be a specific shelf, rack, table, display, etc. on which the item attached to the at least one item tag is located. In some embodiments of the present invention, depending on system design, the determined location may even be as precise as identifying a specific location of the item tag in relation to the fixed object, such as a lower left corner of a specific shelf, rack, table, display, etc. on which the item attached to the at least one item tag is located.

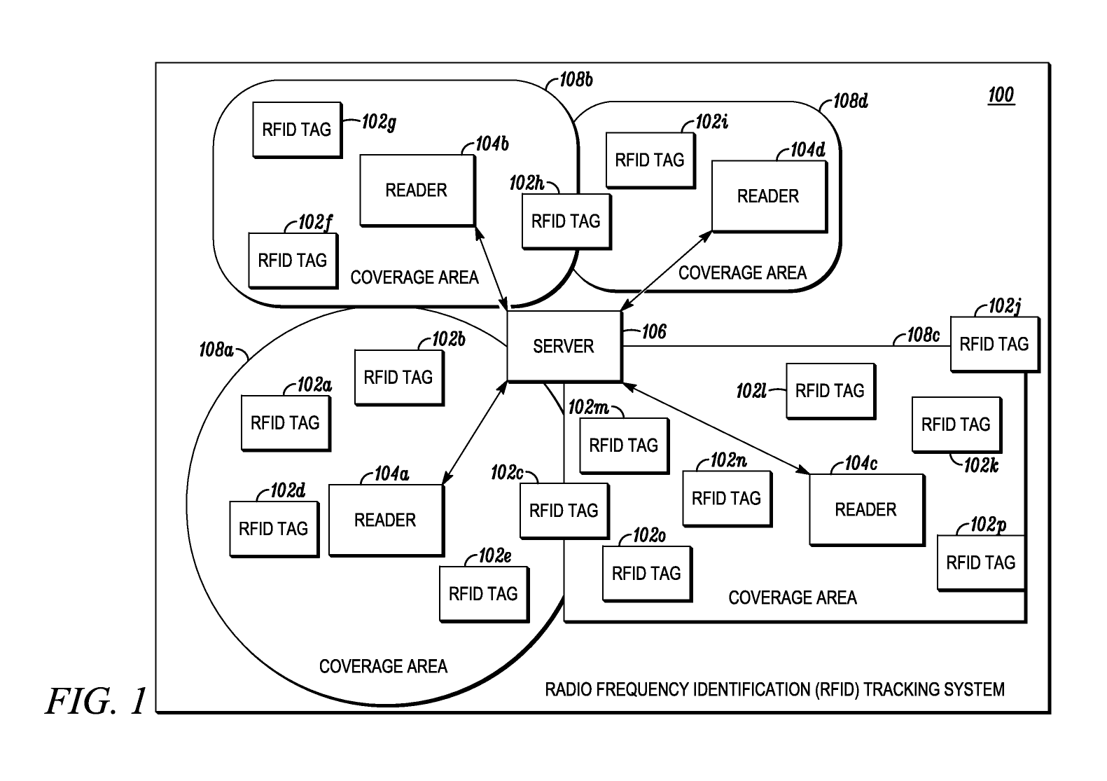

FIG. 1 is a block diagram of a RFID tracking system used in accordance with some embodiments. RFID system 100 includes RFID readers 104 (also referred to herein as readers 104), each of which is configured to send and receive radio frequency (RF) signals within a coverage area 108. Readers 104 may operate independently or may be coupled together to form a reader network. Each reader 104 is also configured to communicate with one or more RFID tags 102 (also referred to herein as item tags 102), within its coverage area. RFID tags 102 can be affixed or attached to one or more items in order to track items within an establishment. Each reader 104 may interrogate item tags 102 within its coverage area 108 by transmitting an interrogation signal to item tags 102 within the reader's coverage area. Item tags 102 within the reader's coverage area may transmit one or more response signals to the reader in a variety of ways, including by alternatively reflecting and absorbing portions of the interrogation signal according to a time-based pattern or frequency. The period during which the interrogation signal and the response signals are sent between reader 104 and item tags 102 is referred to herein as an interrogation period.

Each item tag 102 may be configured to convey information identifying the type of item to which it is attached or affixed so that the location determination can be quickly accomplished through RFID interrogation. It should be noted that item tags 102 may be affixed or attached to individual items or to a group of items. Upon receiving response signals from item tags 102 within the reader's coverage area, each reader 104 is configured to obtain data, such as an identification number of each responding item tag 102, from the response signals. Readers 104 then transmit data obtained from item tags 102 to a central server 106. RFID readers 104 may be wirelessly connected to server 106 via, for example, a Wi-Fi access point. RFID readers 104 may also be connected to server 106 via wired connections.

In general, item tags 102 can be classified as active tags, passive tags, or semi-passive tags, depending on how the signal is induced in the item tag. Active tags include an internal power source and a conventional radio transmitter to continuously power its RF communication circuitry. Semi-passive tags have a local battery to simulate the tag circuitry, but do not have a conventional radio transmitter. Passive tags, on the other hand, have no internal power source but rely on external sources to stimulate signal transmission. For example, passive tags may obtain the power required to stimulate signal transmission from interrogation signals sent from the reader. Active tags are therefore larger and more expensive than passive tags at least because of the added power source in the active tags.

According to some embodiments, a passive RFID tag is attached to each item to be tracked in an area and RFID readers 104 are placed across the tracking area to provide RF coverage and to stimulate signal transmissions from passive RFID tags which are also referred to herein as item tags 102. Some embodiments allow either an active RFID tag, a passive tag, or a semi-passive tag to be attached to each item to be tracked in the area. Each reader 104 periodically interrogates item tags 102 in its coverage area and sends the received tag identifiers to server 106. In order to determine the location of an item tag, for example, item tag 102a, server 106 executes a tag location processor. The tag location processor may be an internal or external processor, which processes one or more quality metrics (for example, read frequencies or received signal strength) associated with the received tag data and calculates the locations of item tags 102 in the establishment. The tag location processor may calculate the locations of item tags 102 within the granularity of a specific fixed object, for example, a rack, shelf or table, on which the items attached to item tags 102 are displayed.

A unique reference tag may be attached to each fixed object used to display items attached to item tags 102, wherein each reference tag is associated with only one fixed object. The reference tag may be attached to a predefined area on each fixed object. For example, the reference tags may be attached to the center of the top shelf on each rack in the tracking area.

In some embodiments, when trying to determine the location of an item attached to a specific item tag, for example, item tag 102a, the tag location processor may compare information, for example, one or more quality metrics, associated with the reference tags with similar information associated with item tag 102a and may determine the location of item tag 102a to be a specific fixed object whose reference tag information is similar to that of item tag 102a with respect to a specific reader. In some implementations, if item tag 102a is read by reader 104a, the tag location processor may assign a weighted number of votes to all fixed objects whose reference tags are also read by reader 104a. The number of votes assigned to each fixed object may depend on the reading frequencies of item tag 102a and the reference tag on the fixed object (i.e. how often reader 104a reads item tag 102a and the reference tags on the fixed objects). In other words, after the tag location processor receives information from all readers in the tracking area, the tag location processor may assign one or more votes to each fixed object that is associated with a reference tag read by a specific reader, for example, reader 104a, if reader 104a also received a signal from the item tag in question, in this case item tag 102a. The tag location processor calculates votes assigned to each fixed object and, in some embodiments, determines the location of item tag 102a to be the fixed object with the highest number of votes. It should be noted that the tag location processor may use another criterion for determining the location of item tag 102a.

In some embodiments, the tag location processor may assign weighted votes to fixed objects associated with reference tags and item tag 102a based on signals received from readers 104 within the tracking area to determine the location of item tag 102a. After receiving signals from reference tags associated with fixed objects and item tag102a, the same or a different number of votes may be assigned to fixed objects attached to the reference tags based on, for example, the similarity between the reading pattern of item tag 102a and the reference tags. This process is repeated for each reader in the system and a final tag location may be determined to be, for example, a rack that has the highest number of aggregated votes from the readers. For example, one vote may be assigned to each fixed object when the reader reads the reference tag associated with the fixed object and the item tag. Accordingly, if the fixed object is read by two readers, the fixed object may be assigned two votes. The fixed object with a maximum number of votes may be determined to be the location of the item tag.

When more than one fixed object has the same number of votes, the tag location processor is configured to resolve the tie and select one of the fixed objects as the location of the item tag. In case of a tie, the tag location processor may compare the item tag's last assigned fixed object with other fixed objects with the same number of votes. If one of the fixed objects with the same number of votes is the item tag's last assigned fixed object, the tag location processor may choose the item tag's last assigned fixed object to be its location. If the item tag's last assigned fixed object is not one of the fixed objects with the same number of votes, and if a reader has a higher read frequency for the item tag than other readers in a coverage area, the tag location processor may choose a fixed object that is closest to the reader that has the higher read frequency. The tag location processor may also randomly choose a fixed object from the group of fixed objects with the same number of votes to be the item tag's new location.

Votes assigned by the tag location processor may be accumulated for a predefined period or over a predetermined set of read cycles for each reader before the tag location processor determines the location of item tag 102a. The accumulation of votes negates effects of read volatility associated with RFID technology and takes into account the various reading frequencies of readers in the tracking area. The reading frequency of item tag 102a with respect to a reader decreases, on average, with the distance between item tag 102a and the reader. If item tag 102a is read more frequently, by for example reader 104a, it can be assumed that item tag 102a is closer to reader 104a as compared to other readers in the tracking area. The tag location processor is also sent information for fixed objects within each reader's coverage area. In some embodiments, each fixed object is assigned a unique identifier and each fixed object may be covered by a unique set of readers. The unique identifier for each fixed object may therefore be used to distinguish one fixed object from another within each reader's coverage area.

The use of one reference tag per fixed object helps in determining the location of item tag 102a with the granularity of a specific fixed object, for example a specific rack or shelf, on which the item tagged with tag 102a is displayed. Each fixed object may also be associated with more than one reference tags to help in determining a location of the item tagged with tag 102a. When more than one reference tags is affixed to a fixed object, each of the reference tags may be affixed to a different location of the fixed object. For example, one reference tag could be affixed to the top of a shelf, another reference tag could be affixed to the bottom of the shelf, one reference tag could be affixed to the right of the shelf, another reference tag could be affixed to the left of the shelf, and so on. The reference tags assigned to the shelf may therefore be used to determine a location of item tag 102a with the granularity of, for example, a specific location, such as a left, right or center position of a specific shelf

In some embodiments, if information from item tag 102a is retrieved by reader 104a, the tag location processor assigns one or more votes to all fixed objects that are also covered by reader 104a. If information from item tag 102a is not retrieved by reader 104a, the tag location processor deducts one or more votes from all fixed objects covered by reader 104a. After processing information from all readers in the tracking area, the tag location processor assigns weighted votes to or deducts votes from the fixed objects in the tracking area, depending on whether or not a reader has retrieved information from item tag 102a. After information is received from all readers in the tracking area, the tag location processor is configured to calculate the votes assigned to each fixed object, wherein the tag location processor uses a predefined criterion, such as, the highest number of votes, to determine the location of item tag 102a.

By assigning weighted votes to specific fixed objects on which tagged items are displayed or stored, the server can automatically and quickly keep track of the locations of items in the tracking area. This helps to facilitate retrieval of tagged items in order to relocate them to their original display locations, thereby increasing the profitability of the establishment and helping in the efficient management of inventory.

Some embodiments are directed to determining the location of an item tag without using any reference tags. In these embodiments, the system may be preconfigured with the information about each reader's coverage, that is, the system is preconfigured with information about all fixed objects covered by each reader. If an item tag is seen by a reader, one or more weighted votes may be assigned to all the fixed objects which are covered by the reader. If the item tag is not seen by the reader, one or more votes may be deducted from all the fixed objects covered by the reader. In one example, two or more votes may be assigned to all the fixed objects which are covered by the reader and at least one vote is assigned or deducted from all the fixed objects if item tag is not seen by the reader. After processing all the data from the reader, the system determines the location of each tag. These steps may be repeated for each reader in the system. The tag is determined to be located on a fixed object with, for example, the highest number of aggregated votes.

Other embodiments are directed to determining the location of an item tag by using information associated with the reference tags attached to the fixed objects. Because of the reference tags, the system does not have to be pre-configured with information about all fixed objects covered by each reader. In these embodiments, the system learns about the reader's coverage on its own with the help of reference tags. If a reference tag is seen by a reader, this means the fixed object on which this reference tag is attached is within the reader's coverage area. The system compares the behavior of an item tag with the reference tags with respect to each reader and assigns votes to or deducts votes from the fixed object.

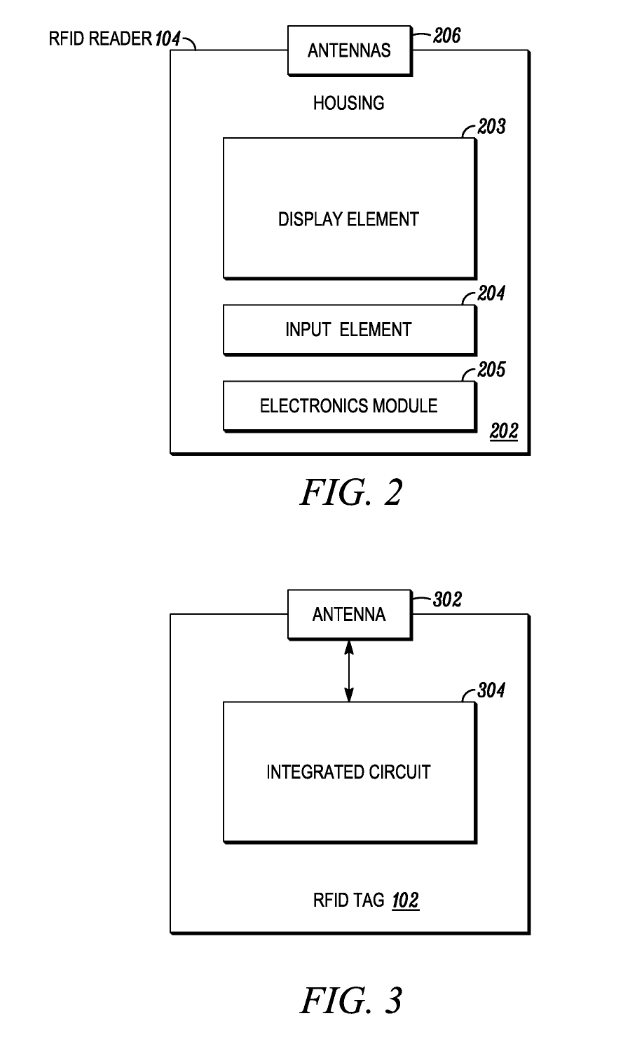

FIG. 2 is a block diagram of a RFID reader used in accordance with some embodiments. RFID reader 104 generally includes a housing 202, a display element 203 that is visible from the outside of the housing 202, an input element 204 that is accessible from the outside of the housing 202, an electronics module 205 contained within the housing 202, and one or more RFID antenna 206 (which can be, but is not necessarily, contained within the housing 202). Input element 204 may be a keypad, a touch panel or other input/output element. The display element 203 and input element 204 function as input/output elements during use of reader 104. Display element 203 and input element 204 can be coupled to electronics module 205 as necessary to support input/output functions in a conventional manner. Electronics module 205 may incorporate hardware components and software functionality of RFID reader 104. In some embodiments, electronics module 205 can be physically realized as an integrated component, board, card, or package mounted within the housing 202. Electronics module 205 may include one or more memory portions for storing instructions, wherein one or more of the memory portions are coupled to one or more processors for performing functions associated with RFID reader 104. Electronics module 205 can be coupled to the RFID antenna 206 using suitable techniques. For example, the electronics module 205 and the RFID antenna 206 can be connected via an RF cable and RF connector assemblies.

FIG. 3 is a block diagram of a RFID tag used in accordance with some embodiments. RFID tag 102 includes an antenna 302 and an integrated circuit 304. Antenna 302 is configured to receive and transmit RF signals. Integrated circuit 304 is configured to store and process information. RFID tag 102 can be positioned within transmission range of the RFID reader 104. Accordingly, RFID tag 102 can receive an interrogation signal sent from RFID reader 104 with antenna 302. Integrated circuit 304 can perform one or more operations in response to receiving the interrogation signal, including modulating the interrogation signal. After processing the interrogation signal, RFID tag 102 can transmit a response signal to RFID reader 104 through antenna 302. Upon receipt of the response signal, RFID reader 104 may extract information from the response signal and transmit the extracted information to the central server.

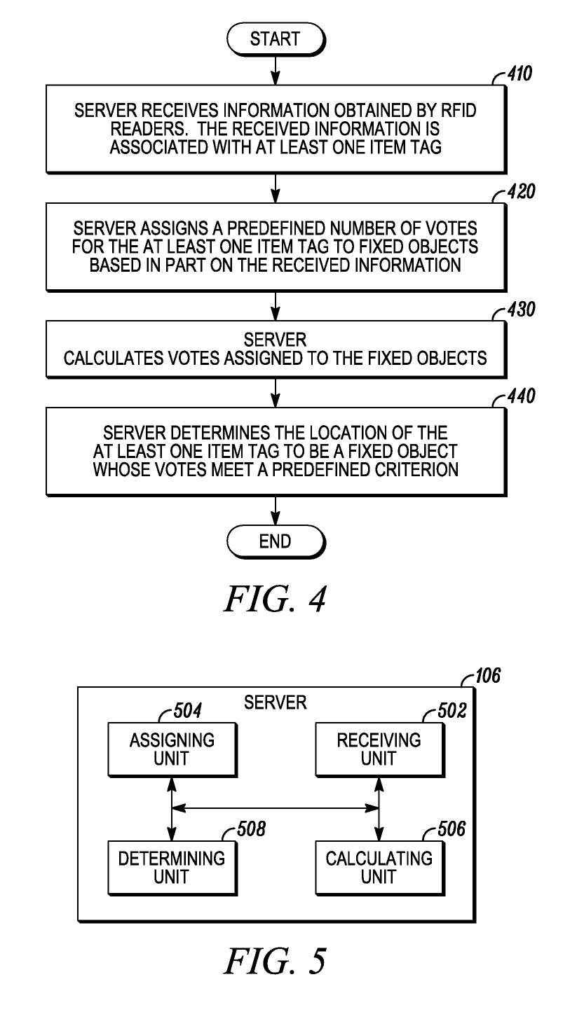

FIG. 4 is a flow diagram of a method for determining the location of at least one item tag in accordance with some embodiments. In 410, a server receives information obtained by at least one RFID reader within a coverage area. The received information is associated with the at least one item tag. In 420, the server assigns a predefined number of votes for the at least one item tag to fixed objects based in part on the received information. In 430, the server calculates votes assigned to the fixed objects. In 440, the server determines the location of the at least one item tag to be a fixed object whose votes meet a predefined criterion.

FIG. 5 is a block diagram of a server configured to determine a location of at least one item tag in accordance with some embodiments. The server is in communications with at least one RFID reader. The server includes a receiving unit 502, an assigning unit 504, a calculating unit 506 and a determining unit 508. Receiving unit 502 is configured to receive information obtained by the at least one RFID reader within a coverage area. The received information is associated with the at least one item tag and reference tags. Assigning unit 504 is configured to assign a predefined number of votes for the at least one item tag to the fixed objects based on the received information. Calculating unit 506 is configured to calculate votes assigned to the fixed objects. Determining unit 508 is configured to determine the location of the at least one item tag to be a fixed object whose votes meet a predefined criterion.

The server, for example, can be an integrated unit containing at least all the elements depicted in FIG. 5, as well as any other elements necessary for the server to perform its particular functions. Alternatively, the server can include a collection of appropriately interconnected units or devices, wherein such units or devices perform functions that are equivalent to the functions performed by the elements of the server. In some embodiments, the server may include a random access memory and a programmable memory that are coupled to a processor. The processor may include ports for coupling to wireless network interfaces. The wireless network interfaces can be used to enable the server to communicate with other devices such as the RFID readers in the RFID network. The programmable memory can store operating code (OC) for the processor and code for performing functions associated with the server. For example, the programmable memory can include computer readable program code components configured to cause execution of a method for enabling the server to determine a location of at least one item tag in accordance with some embodiments as described herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g. comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, in a server in communications with two or more Radio Frequency Identification (RFID) readers, of determining a location of at least one item tag, the method comprising:
receiving information obtained by the two or more RFID readers within a coverage area, wherein received information is associated with the at least one item tag;
assigning a predefined number of votes for the at least one item tag to fixed objects on which items attached to item tags are located, wherein the predefined number of votes are assigned based in part on received information;
calculating votes assigned to the fixed objects; and
determining the location of the at least one item tag to be a fixed object whose votes meet a predefined criterion.

2. The method of claim 1, wherein the assigning comprises assigning the predefined number of votes for the at least one item tag to the fixed objects based in part on information previously stored on the server.

3. The method of claim 1, wherein the assigning comprises assigning at least one vote to each fixed object known to be in at least one RFID reader coverage area when the at least one RFID reader also reads the at least one item tag.

4. The method of claim 1, wherein the assigning comprises deducting at least one vote from each fixed object known to be in at least one RFID reader coverage area when the at least one RFID reader does not read the at least one item tag.

5. The method of claim 1, wherein the calculating comprises accumulating votes assigned to the fixed object by one or more RFID readers whose predetermined coverage areas are known to include the fixed object.

6. The method of claim 1, wherein the calculating comprises accumulating votes assigned to the fixed object by one or more RFID readers that read the reference tag associated with the fixed object.

7. The method of claim 1, wherein the determining comprises resolving a tie between two or more fixed objects associated with reference tags whose votes meet the predefined criterion.

8. The method of claim 7, wherein the resolving the tie comprises:
selecting one of the two or more fixed objects as the location of the at least one item tag if the one of the two or more fixed objects was the last assigned fixed object for the at least one item tag;
selecting the one of the two or more fixed objects as the location of the at least one item tag if the one of the two or more fixed objects is in a coverage area of a reader with a predefined read frequency, or randomly selecting the one of the two or more fixed objects as the location of the at least one item tag.

9. The method of claim 1, further comprising comparing at least one quality metric associated with a reference tag attached to each fixed object to a similar quality metric associated with the at least one item tag, wherein the predefined criterion specifies the location of the at least one item tag to be the fixed object whose quality metric is similar to the quality metric associated with the at least one item tag.

10. The method of claim 9, wherein the quality metric is at least one of a read frequency or a received signal strength indicator.

11. The method of claim 1, wherein the predefined criterion specifies the location of the at least one item tag to be the fixed object with the highest number of votes.

12. The method of claim 1, wherein one or more reference tags is affixed to the fixed object configured to display an item attached to the at least one item tag.

13. A server in communications with two or more Radio Frequency Identification (RFID) readers and configured to determine a location of at least one item tag, the server comprising:
a receiving unit configured to receive information obtained by the two or more RFID readers within a coverage area, the received information being associated with the at least one item tag;
an assigning unit configured to assign a predefined number of votes for the at least one item tag to fixed objects in the coverage area, wherein items attached to item tags are located on the fixed objects and the predefined number of votes are assigned based in part on the received information;
a calculating unit configured to calculate votes assigned to the fixed objects; and
a determining unit configured to determine the location of the at least one item tag to be a fixed object whose votes meet a predefined criterion.

14. The server of claim 13, wherein the assigning unit is configured to assign at least one vote to each fixed object known to be in at least one RFID reader coverage area when the at least one RFID reader also reads the at least one item tag.

15. The server of claim 13, wherein the assigning unit is configured to deduct at least one vote from each fixed object known to be in at least one RFID reader coverage area when the at least one RFID reader does not read the at least one item tag.

16. The server of claim 13, wherein the calculating unit is configured to accumulate votes assigned to the fixed object by one or more RFID readers whose predetermined coverage areas are known to include the fixed object.

17. The server of claim 13, wherein the calculating unit is configured to accumulate votes assigned to the fixed object by one or more RFID readers that read the reference tag associated with the fixed object.

18. The server of claim 13, wherein the determining unit is configured to resolve a tie between two or more fixed objects whose votes meet the predefined criterion.

19. The server of claim 18, wherein the determining unit is configured to resolve the tie by:
selecting one of the two or more fixed objects as the location of the at least one item tag if the one of the two or more fixed objects was the last assigned fixed object for the at least one item tag;
selecting the one of the two or more fixed objects as the location of the at least one item tag if the one of the two or more fixed objects is in a coverage area of a reader with a predefined read frequency, or
randomly selecting the one of the two or more fixed objects as the location of the at least one item tag.

20. The server of claim 13, further comprising a comparing unit configured to compare at least one quality metric associated with a reference tag attached to each fixed object to a similar quality metric associated with the at least one item tag, wherein the predefined criterion specifies the location of the at least one item tag to be the fixed object whose quality metric is similar to the quality metric associated with the at least one item tag, and wherein the quality metric is at least one of a read frequency or a received signal strength.

21. The server of claim 13, wherein the predefined criterion specifies the location of the at least one item tag to be the fixed object with the highest number of votes.
